(19) United States
(12) Patent Application Publication
(10) Pub. No.: US 2002/0035035 A1
(43) Pub. Date: Mar. 21, 2002

(54) Stable, highly active perovskite catalysts for complete oxidation at high temperatures, and the process for their preparation

(76) Inventors: Jitka Kirchnerova, Montreal (CA); Danilo Klvana, Montreal (CA)

Correspondence Address: THE MAXHAM FIRM, 750 "B" STREET, SUITE 3100, SAN DIEGO, CA, 92101, US

(21) Appl. No.: 09/883,675

(22) Filed: Jun. 18, 2001

Related U.S. Application Data
(63) Continuation-in-part of application No. 09/146,452, filed on Sep. 3, 1998.

(51) Int. Cl. B01J 23/74; C01G 49/02

(52) U.S. Cl. 502/324; 502/337; 502/338; 502/325; 502/302; 502/330; 502/332; 502/335; 502/336; 423/599; 423/594

(57) ABSTRACT

Thermostable metal oxide catalysts of the general formula ABMO_{3-δ}, having a perovskite crystal structure and the process of making the same. A, B and M are metal cations. M acts as a doping of site B in an amount of about 0.01 to about 0.30. Cations A, B and M are so chosen as to assure a depletion in oxygen represented by δ of at least 0.02. The catalysts according to the present invention show good catalytic properties even at temperatures above 1300 ° C.

### TITLE OF THE INVENTION

Stable, highly active perovskite catalysts for complete oxidation at high temperatures, and the process for their preparation.

### FIELD OF THE INVENTION

The present invention relates to catalytic materials More specifically, the present invention is concerned with highly active catalytic materials of perovskite-type structure having high resistance to thermal aging and to the process of their preparation.

### BACKGROUND OF THE INVENTION

Power generation through traditional combustion of fossil fuels, of which natural gas is environmentally the most acceptable, represents a source of large quantities of noxious nitrogen oxides (NOₓ). These emissions can substantially be reduced by using lean combustion mixtures and lowering combustion temperatures However, to sustain combustion of lean mixtures. highly active catalytic materials are needed- Catalytic combustion allows to combust (complete oxidation) fuel/air mixture of very wide range of fuel concentrations, and can even be used in explosive atmospheres. But, the lower the fuel concentration, the more active catalyst is required. Evidently, these catalysts must be able to conserve their catalytic properties in a high temperature environment.

The most active catalysts are those based on noble metals such as palladium and platinum. However, these catalysts are expensive and moreover lose their catalytic properties at temperatures above 1000° C.

Multi-metal oxides having a beta-alumina structure and comprising, for example, aluminium oxide or alkaline earth oxide as the active element, show good catalytic activity, even under high temperatures. However, a major drawback of using such materials as catalysts is that they suffer from low resistance to thermal shock when in form of self supporting structures. They also require complex methods for their preparation.

Transition metal based oxides having perovskite crystal structure represented by the formula La₇₋ₓ,AₓMO₃ wherein A is an alkaline earth metal such as Ca, Sr and Ba, and M is a transition metal such as Co, Mn, Fe and Ni, show high catalytic activity. A drawback of such materials, when the active transition metal is Co, Mn or Fe, is their relatively low melting point. In high temperature environment, they are prone to sintering and they lose their catalytic activities. They are stable only under about 800° C. The use of chrome as the active transition metal lead to better results but they still are not suitable for temperatures above 1100° C. because of the high volatility of chromium in the environment of combustion products. Similarly, platinum group metals, when replacing the transition metals in a perovskite structure, may become volatile and are furthermore expensive.

Stability of the perovskite phase under high temperatures can be obtained by preparing such phase with refractory oxides such as ZrO₃, TiO₂, La₂O₃, Y₂O₃, etc. The resulting materials, described by the general formula ABO₃, (ex. SrZrO₃, SrTiO₃, LaAlO₃) have high melting point and their thermal stability is excellent. However, with such materials, a possible reaction can occur between the two components to form a non-active phase. A non-active phase can also occurs if there is sintering on the surface of the material. These non-active phases usually have a relatively low melting point.

U.S. Pat. No. 4,126,580 presents a perovskite catalyst having improved stability in a wide variety of chemical environments. The elements entering in the composition of these materials are chosen to obtain a material having a high lattice stability index (LSI). This is done by incorporating metals having low first ionization potentials. Indeed, this reference suggests to use materials providing LS) value of less than 12.3 eV to obtain stable catalysts. A drawback of many of these materials, however, is that their catalytic properties seem to decrease rapidly above 1000° C.

U.S. Pat. No. 4,110,251 describes other catalytic compositions having perovskite-type crystal structure and the general formula ABO₃₋₁X₁ where X is fluoride or chloride, and f is about from 0.1 to 1.0. The oxygen deficiency, caused here by the presence of fluoride or chloride, enhances the resistance to reducing environment and increases the thermal stability of the composition. However, like the composition described in U.S. Pat. No. 4,126,580, the composition described in U.S. Pat. No. 4,110,251 does not seem to be adequate for temperatures above 1000° C.

U.S. Pat. No. 5,712,220 presents a composition of matter suitable for use in fabricating components used in solid-state oxygen separation devices and represented by the formula LnₓA′ₓA″ₓB_{y}B′_{y}^{′}B″_{y″}O_{3-z} wherein A′ is a Group I element, A″ is selected from groups I, II and III, and B, B′ and B″ are transition metals. The number Z is a number which renders the compound charge neutral and does not indicates oxygen deficiency in the sense of the present invention. Moreover, the materials described in U.S. Pat. No. 5,712,220 are not suitable for catalytic combustion of hydrocarbons.

### OBJECTS OF THE INVENTION

An object of the present invention is therefore to provide thermally stable highly performing catalytic materials suitable for high temperature applications in relatively corrosive environments.

Another object of the invention is further to provide catalytic materials that can withstand temperatures above 1200° C. and that can still present relatively good catalytic activity.

Another object of the invention is to provide catalytic materials of the general formula ABO₃ having a depletion in oxygen of at least about 0.02.

Still another object of the invention is to provide a simple process to prepare catalytic materials of perovskite-type structure that can be shaped into self-supporting forms or that can be used over other refractory support materials.

### SUMMARY OF THE INVENTION

More specifically, in accordance with the present invention, there is provided a thermostable metal oxide catalyst having the general formula ABO₃ and a perovskite crystal structure, wherein

A represents a cation site which is occupied by at least one metal having an ionic radius between 0.09 nm and 0.15 nm;

B represents a cation site which is occupied by at least one metal having an ionic radius between 0.05 nm and 0.10 nm; and

metal cations A and B are present in about the same stoichiometric proportions. the improvement wherein:

said catalyst has the formula ABO_{3-δ}, wherein δ is a depletion in oxygen of at least about 0.02.

In a preferred embodiment, the catalyst comprises a catalytic metal M, providing a catalyst of formula AB₁₋ₓMₓO_{3-δ}.

In still a more preferred embodiment, the components A, B and M are selected to provide a catalyst lattice stability index (LSI) value of 12.3 eV or greater.

In the most preferred embodiment, the non-volatile catalytic metal is a transition metal of atomic number from 25 to 28 and is equal to or lower than about 0.3; A is selected from La, Sr and mixtures thereof, and B is selected from Zr, Ce, Ti, Y. Al and mixtures thereof Such selections provide from refractory and highly active catalysts.

According to another aspect of the present invention, there is provided a process of preparation of a thermostable metal oxide catalyst having the general formula ABMO_{3-δ}and a perovskite crystal structure, wherein

A represents a cation site which is occupied by at least one metal having an ionic radius between 0.09 nm and 0.15 nm,

B represents a cation site which is occupied by at least one metal having an ionic radius between 0.05 nm and 0.10 nm; and

metal cations A and B are present in about the same stoichiometric proportions:

δ represents a depletion in oxygen of at least 0.02;

M represents a cation site which is occupied by at least one catalytic metal;

A, B and M being selected to provide a LSI value ≧12.3 eV;

comprising the steps of:

a) admixing a precursor of each metal cation A, B and M in the form of an oxide, a hydroxide, a carbonate, a salt, or any mixture thereof, with a water-comprising solution, and allowing them to react to form an aqueous suspension of particles of hydroxides, each of A, B and M being mixed in stoichiometric proportions and overall provide for an oxygen content O_{3-δ};

b) drying said aqueous suspension, whereby dried particles are obtained; and

c) calcining said dried particles.

Other objects, advantages and features of the present invention will become more apparent upon reading of the following non restrictive description of preferred embodiments thereof, given by way of example only with reference to the accompanying drawings.

### DETAILED DESCRIPTION OF THE PREFERRED EMBODIMENTS OF THE INVENTION

The present invention relates to materials having a perovskite crystal structure and represented by the general formula ABO₃. These materials are further characterized in that sites A and B both contain metal cations The general formula teaches that sites A and B are occupied by the same number of cations. The ideal perovskite structure is cubical with the larger cations occupying the corners of the cube and the smaller cations occupying the centre of the cube. The oxygen atoms are located at the centre of each faces of the cube. Thus, cations from A-sites are coordinated with twelve oxygen atoms and cations from B-sites are coordinated with six oxygen atoms. Other perovskite structures, based on variation of the above structure, are also known.

The cations from A-sites are generally occupied by a metal atom having an ionic radius between 0.09 nm and 0.15 nm, while cations from B-sites are generally occupied by a metal atom having an ionic radius between 0.05 nm and 0.10 nm.

More specifically, the materials of the present invention are based on refractory highly stable perovskites that are prepared from refractory oxides such as ZrO₂, TiO₂, La₂O₃, Y₂O₃,CeO₂, Al₂O₃,MgO, CaO and SrO. Although these perovskites exhibit very high melting points and are very stables, they are not good catalysts.

These highly refractory perovskites are rendered catalytically active by doping the B-site with one or more transition metal cations M. In addition, the choice of cations in sites A and B is made in a way to assure that there is a depletion in oxygen of at least 2 percent. These two characteristics of the present invention assure that the refractory materials are not only highly stable, but also catalytically active, even at high temperatures.

The general formula of these refractory highly active catalysts of perovskite structure is AB₁₋ₓMₓO_{3-δ}, with δ≧0.02 (It is to be noted that, for reason of clarity, the δ will be written out of the following equations describing materials according to the present invention, but should always be implied). The doping of B-sites with transition metals has to be well controlled for the thermal stability to be preserved. The estimated maximum level of doping in sites B, to maximize the catalytic properties while preserving the thermal stability, is about 30 percent in stoichiometric proportion A minimum doping of about 1 percent is required, so, in the above formula, 0.01<=x<=0.30.

Experiments have shown that certain elements should preferably be used in order to obtain sufficient oxygen depletion and both thermal stability and good catalytic activity at high temperatures. Cations A are preferably selected from the group consisting of lanthanum, calcium, strontium and mixtures thereof. To assure optimal thermal stability of the catalysts of the present invention, cations B are preferably selected from the group consisting of zirconium, cesium, titanium, yttrium, aluminium and mixture thereof. As mentioned hereinabove, these cations are selected from a group that can form refractory and non volatile oxides.

Doping catalytic metal cations are preferably selected from the group consisting of elements having an atomic number from 25 to 28: manganese, iron, cobalt and nickel. These transition metals are nonvolatile.

This selection of components provide highly stable materials having a LSI value equal to or higher than 12.3 eV which combines stability with high catalytic activity. Lauder (U.S. Pat. No. 4,126,580) teaches that aluminium as one of his favourite stabilizers.

Aluminium has a low ionization potential which decreases the LSI value. Indeed, aluminium is a component which is largely responsible, in Lauder's patent, for the low LSI value. When another stabilizer is used, it increases the LSI value. When that other stabilizer is used, the selection of the other components is such that Lauder et al conclude that the catalytically active materials are not stable and decompose, and correlates this low stability to a LSI value of 12.3 eV or more.

The present invention can show that stable catalysts having LSI value equal or greater than 12.3 eV can be produced. Therefore, at least a part of aluminium that is preferred by Lauder can be replaced by other B cations and doped with the transition metal M, and provide high LSl values as well as high catalytic activity.

The catalytic material of the present invention can be prepared, first, by mixing the precursors of the components of a given perovskite composition. Cations A are preferably provided as nonvolatile oxides or carbonates. Cations B come preferably from refractory oxides of very low volatility. The catalytic transition metal to dope site B is preferably provided in form of an aqueous solution of metal nitrates, although oxides, carbonates or other salts may also be used.

An important point to consider when selecting the counteranion form (oxide, nitrate, carbonate, etc. . . ) is the oxygen content needed in the material of the present invention. When the oxygen requirement is met when oxygen is borne by B, for example, an oxide of B will be used, while A and M will be admixed to the other precursors in other counteranionic forms (carbonate or nitrate, etc.).

All the components are mixed in strictly stoichiometric proportions The resulting suspension is mixed until a homogeneous suspension is obtained. The size of the suspension particles should preferably be smaller than 1 μm. The suspension may be homogenized by milling or by high speed mixing.

The resulting suspension is dried by freeze-drying or spraydrying or by any other convenient method known in the art. The perovskite phase is obtained by calcination at temperatures below 1000° C.

### EXAMPLE 1

### PREPARATION OF Ca(Zr₀₉₂Y₀₀₈)₀₉Ni₀₁O₃

A suspension is obtained by placing 20.00 g of calcium carbonate and 22.50 9 of yttria stabilized (8wt %) zirconia fine powder (Zircar Inc.) into a 250 ml polyethylene bottle and by mixing thoroughly. To this mixture is incorporated 65 ml of a solution containing 5.812 g of nickel dinitrate hexahyd rate. 100 ml of zirconia balls are then added to the resulting suspension. The suspension is milled for two hours, before being quickly frozen by pouring the suspension, with the grinding balls, into liquid nitrogen. The frozen material is then dried under vacuum on a commercial freeze-drier. The balls are separated from the dry precursor powder by sieving. The resulting powder is calcined in two steps without intermediate grinding. Finally the obtained perovskite powder is aged 7 hours at 1300° C.

### EXAMPLE 2

### PREPARATION OF Sr(Zr₀₉₂Y₀₀₈)₀₉Mn₀₁O₃

29.53 g of strontium carbonate are mixed with 22.50 g of yttria stabilized zirconia powder (Zircar Inc.). 65 ml of solution containing 5.74 g of manganese dinitrate hexahydrate is incorporated to the mixture. The resulting suspension is treated as the one described in example 1 .

### EXAMPLE 3

### PREPARATION OF SrTi₀₉Fe₀₁O₃

36.908 g of strontium carbonate, 17.978 g of anatase (titanium dioxide) and 1.996 g gamma iron oxide (γFe₂O₃) are incorporated into 75 ml of distilled water. The resulted suspension is treated as in preceding examples.

### EXAMPLE 4

### PREPARATION OF SrTi₀₈Fe₀₂O₃

22.171 g of iron nitrate nanohydrate is dissolved in 80 ml of distilled water, and the solution is placed into a 250 ml polyethylene bottle. To this solution, 17.534 g of anatase and 40.51 of strontium carbonate are added by small portions. The addition of SrCO₃ is accompanied by the evolution of carbon dioxide. When this ceased, the resulting suspension is treated as in preceding examples.

### EXAMPLE 5

### PREPARATION OF SrTi₀₈Fe₀₁Mn₀₁O₃

Similarly as in example 4, for the preparation of SrTi₀₈Fe₀₂O₃, a mixture of 36.908 g of strontium carbonate, 15.980 g of anatase and 1.998 g of gamma iron oxide are added in small portions to a solution containing 7.176 of manganese nitrate hexahydrate, before doing all the mechanical and thermal manipulations described in preceding examples.

### EXAMPLE 6

### PREPARATION OF SrTi₀₉Co₀₁O₃

Similarly as in example 5, 29.526 g of strontium carbonate well mixed with 14.380 g of anatase are added by small portions to 75 ml of an aqueous solution containing 5.821 g of dissolved cobalt nitrate hexahydrate. The resulting suspension is again treated as in previous examples.

### EXAMPLES 7 TO 9

### PREPARATION OF LaAl₀₉Co₀₁O₃, La₀₈₅Sr₀₁₅Al₀₈₈Fe₀₁₂O₃ AND La₀₈₅Sr₀₁₅Al₀₈₈Fe₀₀₉Co₀₄O₃

These three compositions are prepared using the process described in the World Patent Application No. WO 97/48641 and using suitable amount of precursors.

### EXAMPLE 10

### USE OF THE MATERIALS OF THE PRESENT INVENTION FOR THE CATALYTIC COMBUSTION OF METHANE

Catalytic activity of materials of examples 1 to 9 was tested in a laboratory tubular reactor consisting of alumina ceramic tube having 1.3 cm of internal diameter. The activities are compared to activities of perovskites based only on transition metals (without doping), LaMnO₃,La₀₈Sr_{0.2}MnO₃ and La₀₆₆Sr₀₃₄Ni₀₃Co₀₇O₃ and to those of a beta-alumina: Sr_{0.8}La₀₂MnAl₁₁O_{19-δ}.

The catalytic bed of 1 g catalyst powder diluted (mixed) with 10 ml pumice (particles of size from 350 to 500 μm) filed an annular space between the reactor tube and a thermocouple alumina sheath (0.64 cm diameter) passing in the center. Reaction mixture of 2% methane in air was flowing over the catalyst at 400 ml/min. The reactor was heated in steps of about 50 degrees. When a steady temperature was obtained the effluents were analysed after removing water by a desiccant, by gas-chromatography using Porapak Q column in the case of methane and carbon dioxide.

Table I shows temperatures at which a given conversion (10%, 50% and 90%) of 2% methane in air is obtained over catalysts according to the present invention and other perovskites based only on transition metals without any doping in B-sites. All the materials were aged 26 h at 1070° C.

TABLE I

| | SSA | T₁₀ | T₅₀ | T₉₀ | |
|---|---|---|---|---|---|
| composition | (m₂/g) | (° C.) | (° C.) | (° C.) | LSI* |
| SrTi_{0.8}Fe_{0.2}O₃ | 2.16 | 570 | 690 | 790 | 12.722 |
| SrTi_{0.9}Co_{0.1}O₃ | 1.29 | 580 | 680 | 780 | 12.616 |
| LaAl_{0.9}Co_{0.1}O₃ | 3.19 | 525 | 640 | 770 | 11.782 |
| La_{0.85}Sr_{0.15}Al_{0.88}Fe_{0.12}O₃ | 3.59 | 530 | 650 | 725 | 11.833 |
| La_{0.85}Sr_{0.15}Al_{0.87}Fe_{0.08}Co_{0.4}O₃ | 4.32 | 525 | 625 | 705 | 11.850 |
| LaMnO₃ | 1.03 | 540 | 675 | 825 | 13.042 |
| La_{0.8}Sr_{0.2}MnO₃ | 0.68 | 540 | 705 | 820 | 13.058 |
| La_{0.88}Sr_{0.34}Ni_{0.3}Co_{0.7}O₃ | 0.74 | 610 | 725 | 825 | 13.430 |

*Lattice stability index: sum of products of atomic fractions and first ionization potential, as taught by Lauder (U.S. Pat. No. 4,126,580).

Table 1 shows that five materials according to the present invention have a specific surface area (SSA), and then catalytic activities, greater than catalysts based on transition metals but not doped. One can see that it takes lower temperatures for the materials according to the present invention to convert 90% of methane than the non-doped materials. Even for the conversion of 10% methane, the materials of this invention showed very good catalytic activities.

The LSI values are calculated following the teachings of Lauder in U.S. Pat. No. 4,126,580, which is herein incorporated by reference. It is the sum of the products of the atomic fractions of each cation and the first ionization potential thereof. A list of first ionization potentials is given in Lauder's patent.

Table II presents temperatures at which a given conversion (10%, 50% and 90%) of 2% methane in air is obtained over catalysts according to the present invention. The results are compared to those obtained with a catalyst material having a beta-alumina structure. All the materials were aged in air 4 h at 1070° C. and 7 h at 1300° C.

TABLE II

| | SSA | T₁₀ | T₅₀ | T₉₀ | |
|---|---|---|---|---|---|
| composition | (m₂/g) | (° C.) | (° C.) | (° C.) | LSI |
| Ca(Zr_{0.912}Y_{0.088})_{0.9}Ni_{0.1}O₃ | 1.31 | 655 | 775 | 870 | 12.992 |
| Sr(Zr_{0.912}Y_{0.088})_{0.9}Mn_{0.1}O₃ | 2.75 | 670 | 750 | 810 | 12.555 |
| SrZr_{0.9}Ni_{0.1}O₃ | 4.59 | 575 | 747 | 870 | 12.611 |
| SrTi_{0.9}Fe_{0.1}O₃ | 2.04 | 575 | 700 | 800 | 12.617 |
| SrTi_{0.8}Fe_{0.2}O₃ | 1.37 | 575 | 705 | 840 | 12.722 |
| SrTi_{0.8}Fe_{0.1}Mn_{0.1}O₃ | 1.31 | 610 | 745 | 825 | 12.678 |
| SrTi_{0.85}Fe_{0.12}Mn_{0.03}O₃ | 2.00 | 575 | 675 | 805 | 12.656 |
| La_{0.85}Sr_{0.15}Al_{0.88}Fe_{0.12}O₃ | 1.41 | 600 | 725 | 820 | 11.833 |
| La_{0.85}Sr_{0.15}Al_{0.87}Fe_{0.09}Co_{0.04}O₃ | 1.89 | 560 | 675 | 770 | 11.851 |
| Sr_{0.8}La_{0.2}MnAl₁₁O_{19.8} | 3.97 | 597 | 708 | 804 | — |

The results in table II show that the catalytic activities of materials according to the present invention are similar to those of the best beta-alumina known in the art, or even better. The advantage of the materials according to present invention, compared to beta-alumina is however their simple process of preparation.

Table III shows again temperatures at which a given conversion of 2% methane in air is obtained over some of the catalysts of the last example. The results are still compared to those obtained with the same catalyst material having a beta-alumina structure. The materials were aged in air 7 h at 1300° C. and 6 h at 1450° C.

TABLE III

| | SSA | T₁₀ | T₅₀ | |
|---|---|---|---|---|
| composition | (m₂/g) | (° C.) | (° C.) | LSI |
| Sr(Zr_{0.912}Y_{0.088})_{0.9}Mn_{0.1}O₃ | 1.89 | 664 | 755 | 12.555 |
| SrTi_{0.9}Fe_{0.1}O₃ | 0.70 | 700 | 800 | 12.617 |
| SrTi_{0.8}Fe_{0.2}O₃ | 0.59 | 650 | 805 | 12.722 |
| SrTi_{0.8}Fe_{0.1}Mn_{0.1}O₃ | 0.76 | 650 | 755 | 12.678 |
| La_{0.85}Sr_{0.15}Al_{0.88}Fe_{0.12}O₃ | 0.58 | 645 | 805 | 11.833 |
| La_{0.85}Sr_{0.15}Al_{0.87}Fe_{0.09}Co_{0.04}O₃ | 0.85 | 645 | 780 | 11.851 |
| Sr_{0.8}La_{0.2}MnAl₁₁O_{19.8} | 0.74 | 700 | 775 | — |

Table III shows that some materials according to the present invention have better catalytic activities than the best beta-alumina after being aged at temperatures above 1300° C.

Clearly materials having LSI value of 12.3 eV or greater do not decompose, contrarily to what is taught by Lauder in U.S. Pat. No. 4,126,580.

Although the present invention has been described hereinabove by way of preferred embodiments thereof, it can be modified, without departing from the spirit and nature of the subject invention as defined in the appended claims.

What is claimed is:

1. In a thermostable metal oxide catalyst having the general formula ABO₃ and a perovskite crystal structure, wherein
A represents a cation site which is occupied by at least one metal having an ionic radius between 0.09 nm and 0.15 nm;
B represents a cation site which is occupied by at least one metal having an ionic radius between 0.05 nm and 0.10 nm; and .
metal cations A and B are present in about the same stoichiometric proportions,
the improvement wherein:
said metal cation B site is doped with at least one catalytic metal represented by M, in a stoichiometric proportion x of about 0.01 to about 0.3, to provide a catalyst having the formula AB₁₋ₓMₓO_{3-δ}, with δ being a deficiency in oxygen of at least about 0.02, said at least one catalytic metal M is selected from the group of transition metals having an atomic number form 25 to 28,
wherein A, B and M are selected so as to provide a catalyst that has a lattice stability index value (LSI) equal to or greater than 12.3 electron volts (eV).

2. A thermostable metal oxide catalyst according to claim 1, wherein the metal cation A is selected from the group consisting of lanthanum, calcium, strontium and mixtures thereof.

3. A thermostable metal oxide catalyst according to claim 1, wherein the metal cation B is selected from the group consisting of zirconium, cesium, titanium, yttrium, aluminium and mixtures thereof.

4. A thermostable metal oxide catalyst according to claim 2, wherein the metal cation B is selected from the group consisting of zirconium, cesium, titanium, yttrium, aluminium and mixtures thereof

5. A thermostable metal oxide catalyst according to claim 4, which has a formula SrZr₁₋ₓMₓO_{3-δ}, wherein x≦0.3.

6. A thermostable metal oxide catalyst according to claim 4, which has a formula CaZr_{1-xM}ₓO_{3-δ}, wherein x≦0.3.

7. A thermostable metal oxide catalyst according to claim 4, which has a formula SrTi₁₋ₓMₓO_{3-δ}, wherein x≦0.3.

8. A thermostable metal oxide catalyst according to claim 7, wherein M is iron (Fe).

9. A thermostable metal oxide catalyst according to claim 7, wherein M is a mixture of iron (Fe) and cobalt (Co).

10. A process of preparation of a thermostable metal oxide catalyst having the general formula A₁₋ₓBₓMO_{3-δ}and a perovskite crystal structure, wherein
A represents a cation site which is occupied by at least one metal having an ionic radius between 0.09 nm and 0.15 nm;
B represents a cation site which is occupied by at least one metal having an ionic radius between 0.05 nm and 0.10 nm;
metal cations A and B are present in about the same stoichiometric proportions;
δ represents a deficiency in oxygen of at least 0.02;
M represents a cation site which is occupied by at least one catalytic metal, In a stoichiometric proportion x of about 0.01 to about 0.3, said catalytic metal M is selected from the group of transition metals having an atomic number from 25 to 28; and
A, B and M are selected to provide a lattice stability index of 12.3 eV or greater to the catalyst, comprising the steps of:
a) using a precursor of each metal cation A, B and M to form an aqueous suspension of particles, said precursors being mixed in stoichiometric proportions and overall providing for a depletion in oxygen of δ oxygen content O_{3-δ:}
b) crying said aqueous suspension, whereby dried particles are obtained; and
c) calcining said dried particles.

11. A process of preparation of a thermostable metal oxide catalyst according to claim 10, where calcining step c) is done at temperatures below 1000° C.

12. A process of preparation of a thermostable metal oxide catalyst according to claim 10, wherein said precursor of the metal cation M is a salt.

13. A process of preparation of a thermostable metal oxide catalyst according to claim 12, wherein said salt is a nitrate

14. A process of preparation of a thermostable metal oxide catalyst according to claim 10, wherein the metal cation A is selected from the group consisting of lanthanum, calcium, strontium and mixtures thereof, and the precursor form thereof is an insoluble oxide or carbonate.

15. A process of preparation of a thermostable metal oxide catalyst according to claim 13, wherein the metal cation A is selected from the group consisting of lanthanum, calcium, strontium and mixtures thereof, and the precursor form thereof is an insoluble oxide or carbonate.

16. A process of preparation of a thermostable metal oxide catalyst according to claim 10, wherein the metal cation B is selected from the group consisting of zirconium, cesium, titanium, yttrium, aluminium and mixtures thereof, and the precursor form thereof is an insoluble oxide or carbonate.

17. A process of preparation of a thermostable metal oxide catalyst according to claim 14, wherein the metal cation B is selected from the group consisting of zirconium, cesium, titanium, yttrium, aluminium and mixtures thereof, and the precursor form thereof is an insoluble oxide or carbonate.

18. A process of preparation of a thermostable metal oxide catalyst according to claim 15, wherein the metal cation B is selected from the group consisting of zirconium, cesium, titanium, yttrium, aluminium and mixtures thereof, and the precursor form thereof is an insoluble oxide or carbonate.

19. A thermostable metal oxide catalyst having the general formula ABO₃ and a perovskite crystal structure, wherein
A represents a cation which is occupied by at least one metal that can form a refractory nonvolatile oxide;
B represents a cation site which is occupied by at least one metal that can form a refractory nonvolatile oxide;
metal cations A and B are present in about the same stoichiometric proportions, said metal cation site B is doped with at least one catalytic metal cation M in stoichiometric proportion of about 0.01 to about 0 3, said at least one catalytic metal is selected from the group of transition metals having an atomic number from 25 to 28; and
cations A, B and M are selected to provide a catalyst having a depletion in oxygen of at least about 0.02 in stoichiometric proportion and an overall LSI value equal to or greater than 12.3 eV.

20. In a thermostable metal oxide catalyst having the general formula ABO₃ and a perovskite crystal structure, wherein
A represents a cation site which is occupied by at least one metal that can form a refractory nonvolatile oxide;
B represent a cation site which is occupied by a at least one metal that can form a refractory nonvolatile oxide; and
metal cations A and B are present in about the same stoichiometric proportions:
the improvement wherein:
said metal cation B is doped with at least one catalytic metal represented by M, in a stoichiometric proportion x of about 0.01 to about 0.3, to provide a catalyst having the general formula AB₁₋ₓMₓO_{3-δ}, with δ being a deficiency in oxygen of at least about 0.02, said catalytic metal M is selected from the group of transition metals having an atomic number from 25 to 28, and A, B and M are selected to provide a catalyst LSI value equal to or greater than 12.3 eV.
